(19) United States
(12) Patent Application Publication
(10) Pub. No.: US 2016/0091406 A1
(43) Pub. Date: Mar. 31, 2016

(54) METHOD FOR EVALUATING RANGE OF SHEAR RATE ACTING ON FLUID, AND PROGRAM AND DEVICE FOR SAME

(71) Applicant: A&D CAMPANY, LIMITED, Tokyo (JP)

(72) Inventors: Naoto IZUMO, Saitama (JP); Yuji FUKAMI, Saitama (JP)

(21) Appl. No.: 14/892,438

(22) PCT Filed: Aug. 29, 2013
(86) PCT No.: PCT/JP2013/073153

§ 371 Date: Nov. 19, 2015

(51) Int. Cl. G01N 11/16

(52) U.S. Cl. CPC G01N 11/16

(57) ABSTRACT

To provide a method and an apparatus for evaluating a reachable range of a shear rate of a fluid by using a concept of a shear rate propagation constant in evaluating the properties of the fluid. The apparatus for measuring a viscosity in which a vibrator (1) dunked in the fluid and to be measured is vibrated for measuring the viscosity by means of an amplitude change which is influenced by a viscosity resistance of the fluid includes a step (S1) of measuring a fluid density, a step (S2) of measuring the fluid viscosity, a step (S3) of calculating an angular frequency of the vibrator, and a step (S4) of calculating a shear rate propagation constant “Z” from Equation (1), wherein increase of the shear rate propagation constant “Z” is evaluated as increase of a reachable range of the shear rate applied to the fluid from the vibrator (1).

### TECHNICAL FIELD

The present invention relates to a method of evaluating properties of a fluid and, particularly, relates to the method of evaluating a reachable range of a shear rate exerted on the fluid, its program and apparatus.

### BACKGROUND ART

In order to evaluate properties of a fluid, the change of a shear rate is indispensable. In a rotational viscometer known as an apparatus for evaluating the properties of the fluid, a viscosity is determined by measuring a torque which is necessary for maintaining a rotor's fixed rotation number in a sample liquid, and the shear rate is determined in accordance with a concept that the rotor's rotation number is proportional to the shear rate.

As shown in FIG. 6, for example, in a cone plate rotational type viscometer, when a conical rotor 32 dunked in the sample liquid 9 is rotated at a rotation number N [rpm] under a condition a flat plate stands still, a shear rate D generated in the sample liquid satisfies an Equation (2) at an arbitrary diameter “r” assuming that the diameter of the rotor 32 is “R”. The shear rate D which is not related to the diameter “r” can be determined with the rotation number N and a cone angle on all positions of the conical surface.

$$\begin{matrix}[ Equation 2 ] & \\ D = \frac{2 π Nr}{60} \times \frac{1}{r φ} = \frac{2 π N}{60} \times \frac{1}{φ} & ( 2 )\end{matrix}$$

### PRIOR ART REFERENCES

### Patent References

Patent Reference 1: JP-A-9-61333

### SUMMARY OF INVENTION

### Technical Problem

It is understood that when the shear rate exerted on the fluid is constant and the fluid maintains the uniform structure in a proportional fashion with respect to the shear rate change, the shear stress proportional to the shear rate is ideally obtained and the viscosity is made constant. However, in a non-Newtonian fluid, no proportional relation exists between the shear rate change and the shear stress change, and, as a result, the viscosity defined as a proportionality constant is not a constant value. The non-proportionality of the shear rate generated in the liquid with respect to the rotation number of the rotational viscometer is practically considered to be a contributory factor of the non-linearity of the non-Newtonian fluid.

In spite of this factor, as mentioned above, the shear rate is hypothetically calculated from the geometrical shape of the viscometer apparatus and the rotation number of the rotor even in the rotational viscometer in which the shear rate can be calculated, and especially the propagation of the shear rate or the reachable range of the shear rate has not been conventionally considered.

If the actual conditions of the shear rate which is an important factor of evaluating the properties of the fluid can be evaluated, the clarification of the behaviors of the liquid containing the non-Newtonian fluid may be started.

The present invention is to propose a new method of, by using a concept of a propagation constant of a shear rate, evaluating a reachable range of the shear rate of a fluid for evaluating the properties of the fluid in order to overcome the problems of the prior art, and in addition its program and apparatus.

### Means of Solving Problems

The present invention for achieving the above object has the configuration of a method of evaluating a property of a fluid in an apparatus for measuring a viscosity in which a vibrator dunked in the fluid and to be measured is vibrated for measuring the viscosity by means of an amplitude change which is influenced by a viscosity resistance of the fluid, the method including a step of measuring a density “ρ” of the fluid, a step of measuring the viscosity “η” of the fluid, a step of calculating an angular frequency “ω” of the vibrator, and a step of calculating a shear rate propagation constant “Z” in accordance with an Equation (1) below, wherein an increase of the shear rate propagation constant “Z” is evaluated as an increase of a reachable range of the shear rate applied to the fluid from the vibrator.

$$\begin{matrix}[ Equation 1 ] & \\ Z = \frac{1}{\sqrt{\frac{ω ρ}{η}}} & ( 1 )\end{matrix}$$

A method of evaluating a property of a fluid in accordance with the present invention is the method of evaluating the property of the fluid in an apparatus for measuring a viscosity in which a vibrator dunked in the fluid and to be measured is vibrated for measuring the viscosity by means of an amplitude change which is influenced by a viscosity resistance of the fluid, the method including, a step of measuring a density “ρ” of the fluid, a step of measuring the viscosity “η” of the fluid, a step of calculating an angular frequency “ω” of the vibrator, and a step of calculating a shear rate propagation constant “Z” in accordance with an Equation (1) below, wherein a reachable range of the shear rate is quantified by using the shear rate propagation constant “Z”.

$$\begin{matrix}[ Equation 1 ] & \\ Z = \frac{1}{\sqrt{\frac{ω ρ}{η}}} & ( 1 )\end{matrix}$$

A tuning-fork vibration type viscometer in accordance with the present invention includes a pair of vibrators dunked in a fluid to be measured, an electromagnetic drive provided with a coil for driving the vibrators, wherein a driving current is applied to the coil such that an amplitude of the vibrators which is changed by a viscosity resistance of the fluid reaches a predetermined value, and a viscosity “η” of the fluid is obtained by measuring the driving current, an angular frequency “ω” of the vibrators is calculated, and a means of calculating a shear rate propagation constant “Z” is provided in an operation processing part in accordance with an Equation (1) below and by using the angular frequency “ω”, the viscosity “η” and a density “ρ” of the fluid.

$$\begin{matrix}[ Equation 1 ] & \\ Z = \frac{1}{\sqrt{\frac{ω ρ}{η}}} & ( 1 )\end{matrix}$$

The present invention is a program of calculating the shear rate propagation constant which is written in accordance with the method of evaluating the property of a fluid in an apparatus claimed in claim 1 or 2, and is executable.

### Advantageous Effect of Invention

In accordance with the present invention, the quantitative evaluation of the propagation of the shear rate which has not been considered can be performed in the apparatus for measuring the viscosity for evaluating the properties of the fluid from the viscosity measurement and so on.

The reachable range of the shear rate exerted on the fluid from the vibrator can be quantified for performing the quantitative evaluation by utilizing a new concept of the shear rate propagation constant “Z” which can be calculated by obtaining the density “ρ” of the fluid, the viscosity “η” of the fluid and the angular frequency “ω” of the vibrator in the apparatus for measuring the viscosity in which the vibrator dunked in the fluid and to be measured is vibrated for measuring the viscosity by means of the amplitude change which is influenced by the viscosity resistance of the fluid. The shear rate propagation constant “Z” refers to a distance “y” in the right angle from the vibration surface of the vibrator having an attenuation rate (δ) of vibration of 63.2%, and the influence of the shear rate is far-reaching with the increase of the shear rate propagation constant “Z” so that the reachable range of the shear rate is evaluated to be larger.

### BRIEF DESCRIPTION OF DRAWINGS

FIG. 1 is a schematic view of an entire configuration of a tuning fork vibration type viscometer in accordance with the present invention.

FIG. 2 is a schematic configuration of a drive mechanism part of the tuning fork vibration type viscometer.

FIG. 3 is a block diagram of a driving and controlling system of the tuning fork vibration type viscometer.

FIG. 4 is a graph showing shear rate propagation constants.

FIG. 5 is a flowchart for calculating the shear rate propagation constant.

FIG. 6 is a schematic view of a measuring part of the cone plate rotational type viscometer.

FIG. 7 is an explanatory diagram showing a vibrator and the vibration of a fluid in contact with the vibrator.

### DESCRIPTION OF EMBODIMENTS

Then, suitable embodiments of the present invention will be described.

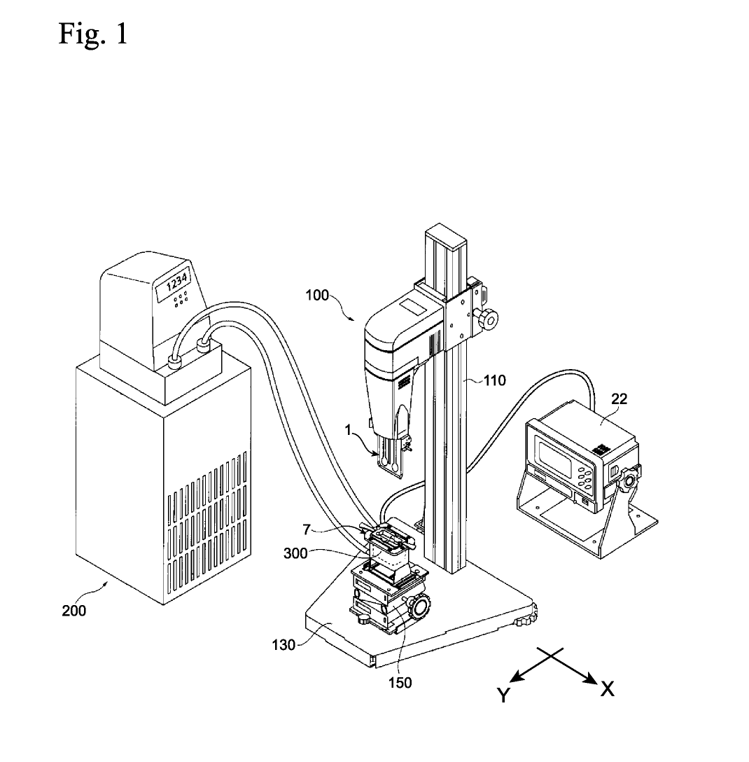

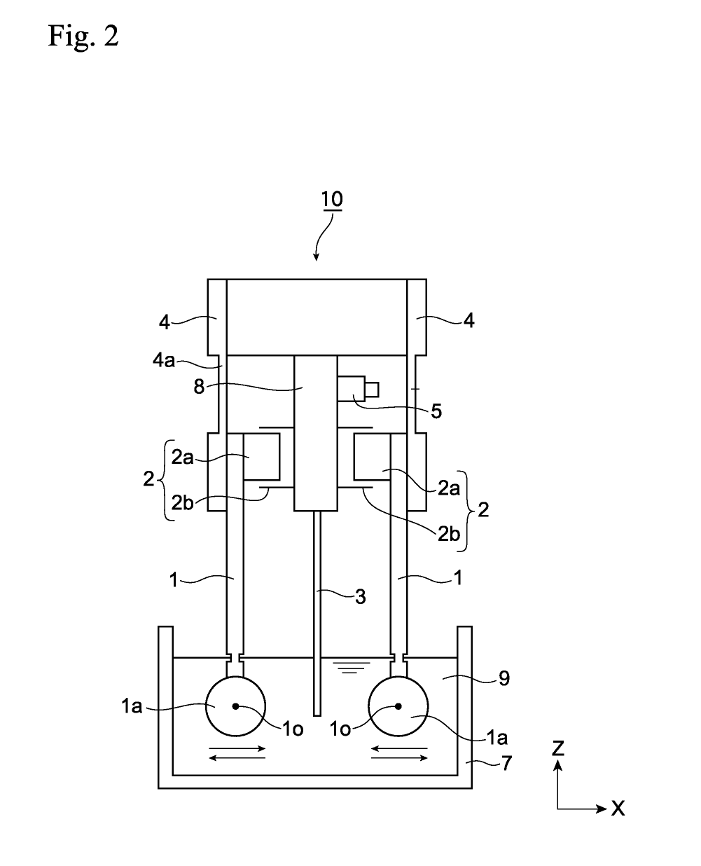

FIG. 1 is a schematic view of an entire configuration of a tuning fork vibration type viscometer in accordance with the present invention, and FIG. 2 is a schematic configuration of a drive mechanism part of the tuning fork vibration type viscometer. The details of a viscometer body 100 and the drive mechanism part 10 are described in JP-A-2005-345211 and WO 2012/074654.

The tuning fork vibration type viscometer in accordance with the present invention includes the viscometer body 100, a temperature sensor 200, a thermostatic bath 300, a sample vessel 7, and a display 22. The viscometer body 100 vertically slides along a support rod 110. An XYZ stage 150 is fixed on the center of the top surface of a base board 130, and the vessel 7 can be movably adjusted in a horizontal direction (X-Y direction) and in a vertical direction (Z direction).

Symbols 1,1 in the drive mechanism part 10 denote a pair of vibrators dunked in a sample liquid 9 for a fluid which is a subject of measurement. The vibrators are made of a thin and flat plate such as a ceramic member or a metallic member, and circular enlarged portions which act as vibration surfaces 1a are formed on the front sections. The pair of the vibrators 1,1 are arranged such that their central axes in the thickness direction are on the same plane in the sample liquid 9.

A symbol 3 denotes a temperature sensor, symbols 4,4 denote plate springs having the vibrators 1,1 fixed at their top ends, and a symbol 8 denotes a central supporting member for fixing the plate springs 4,4. The vibrators 1,1 are configured to be dunked in the sample liquid 9 in the vessel 7 at a constant depth.

A symbol 2b denotes an electromagnetic coil, and a symbol 2a is a neodymium magnet. The vibrators 1,1 mounted at the top ends of the plate springs 4,4 are configured to vibrate in a predetermined value by means of an electromagnetically driving part of a moving magnet system composed of the electromagnetic coil 2b and the neodymium magnet 2a. A symbol 5 denotes a contact-less displacement sensor for detecting an eddy current which measures an amplitude value of the vibrators 1,1.

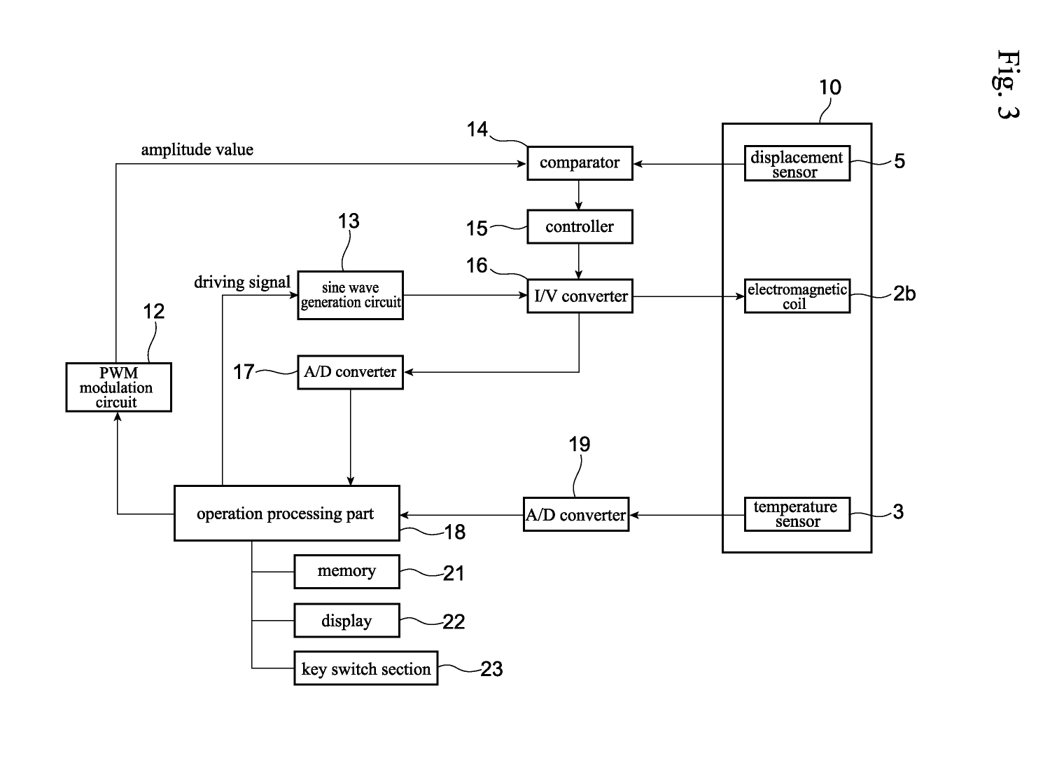

FIG. 3 is a block diagram of a driving and controlling system of the tuning fork vibration type viscometer in accordance with the present invention.

A symbol 12 denotes a PWM modulation circuit, a symbol 13 denotes a sine wave generation circuit, a symbol 14 is a comparator, a symbol 15 denotes a controller, a symbol 16 denotes an I/V converter, symbols 17 and 19 denote A/D converters, and a symbol 18 denotes an operation processing part.

The vibrators 1,1 dunked in the sample liquid 9 receive a driving signal from the operation processing part 18 so as to be vibrated in an predetermined amplitude value, then a driving current generated via the sine wave generation circuit 13 is applied to the electromagnetic coil 2b of the electromagnetic drive 2 and exerted on the plate springs 4,4. In this manner, the vibrators 1,1 are vibrated in a reverse phase and resonated. The amplitude value of the vibrators 1,1 is detected by the displacement sensor 5, the signal of the detected amplitude value is compared with the predetermined amplitude value in the comparator 14, and a signal is outputted from the controller 15 for vibrating the vibrators 1,1 at the predetermined amplitude value, and thereby, a feedback control is executed therein. After the vibrators 1,1 become to be vibrated in the predetermined amplitude value, a driving current “I” applied to the electromagnetic coil 2b is detected. Then, the driving current I is inputted to the operation processing part 18 via the I/V converter 16 and the A/D converter 17, and the viscosity of the sample liquid 9 is calculated. The process of calculating the viscosity is described in JP-A-5-149861. An input signal from the temperature sensor 3 is inputted to the operation processing part 18 via the A/D converter 19 for temperature.

The PWM modulation circuit 12 is connected between the operation processing part 18 and the comparator 14. The predetermined amplitude value is changed arbitrarily by conducting the pulse width modulation to the amplitude value inputted to the comparator 14 by means of orders from the operation processing part 18, and the amplitude of the vibrators 1,1 during the measurement changes for changing the shear rate generated in the sample liquid 9.

A memory 21, a display 22, and a key switch section 23 are connected in the operation processing part 18, and an user can set up conditions of measurement by using the key switch section 23. The conditions of measurement include, for example, a measuring time, setting of the change of the amplitude (inputting an upper limit and a lower limit of the amplitude, the determination of an amount of change of the amplitude per time, and whether the amplitude is raised, fallen or reciprocated). These details are described in WO2012/074654.

Then, a new method of obtaining the reachable range of the shear rate exerted from the vibrators 1,1 to the sample liquid 9 by using the tuning fork vibration type viscometer having the above configuration will be described in detail.

As shown in FIG. 7, when a thin and flat vibration piece restrictively vibrates parallel to its surface at a rate of νₘ×e^{jωt} in a Newtonian fluid, a vibration rate v at a surface separated from the vibration piece by a distance “y” in a perpendicular direction is shown in Equation (3) (Hiroo KAWDA, “Revised Viscosity”, first edition, edited by Keiryo Kanri Kyokai (Measurement Control Association), November, 1958, pages 139 to 143).

$$\begin{matrix}[ Equation 3 ] & \\ υ = {υ}_{m} \times {exp}^{( - \sqrt{\frac{j ω ρ}{η}} y )} \times {e}^{j ω t} & ( 3 )\end{matrix}$$

νₘ: maximum vibration rate of vibration piece

j: √(−1)

ω: angular frequency

ρ: density of fluid

η: viscosity of fluid

t: time

“νₘ” is a known constant obtained from the apparatus configuration, and “e^{jωt}” is a vibrational term. Accordingly, an attenuation rate of the vibration rate at the surface separated from the vibration piece by the distance “y” attenuates with respect to the rate of the vibration piece in accordance with Equation (4).

$$\begin{matrix}[ Equation 4 ] & \\ {exp}^{( - \sqrt{\frac{j ω ρ}{η}} y )} & ( 4 )\end{matrix}$$

In case of no attenuation, if “the vibration rate of the vibration piece at the distance “y”” is assumed to be equal to zero, and the point where the vibration of the fluid disappears is assumed to be equal to 100%, the attenuation rate (δ) is expressed in Equation (5).

$$\begin{matrix}[ Equation 5 ] & \\ δ ( \% ) = ( 1 - {exp}^{( - \sqrt{\frac{ω ρ}{η}} y )} ) \times 100 & ( 5 )\end{matrix}$$

In this manner, the attenuation rate (δ) of the vibration exponentially changes, and it can be understood that the attenuation of the shear rate decreases with the approach to the vibration surface, and increases with the separation from the vibration surface. It is regarded from this phenomenon that the attenuation of the shear rate includes a primary delay element, and the concept of “time constant” can be introduced. When an intersection between the asymptotic curve of the attenuation rate (δ) and a linear line (y=0.632) is obtained, and a distance “y” (mm) where the attenuation rate (δ) is 63.2% is defined to be the propagation constant Z of the shear rate, the reachable range of the shear rate can be evaluated by using the propagation constant Z.

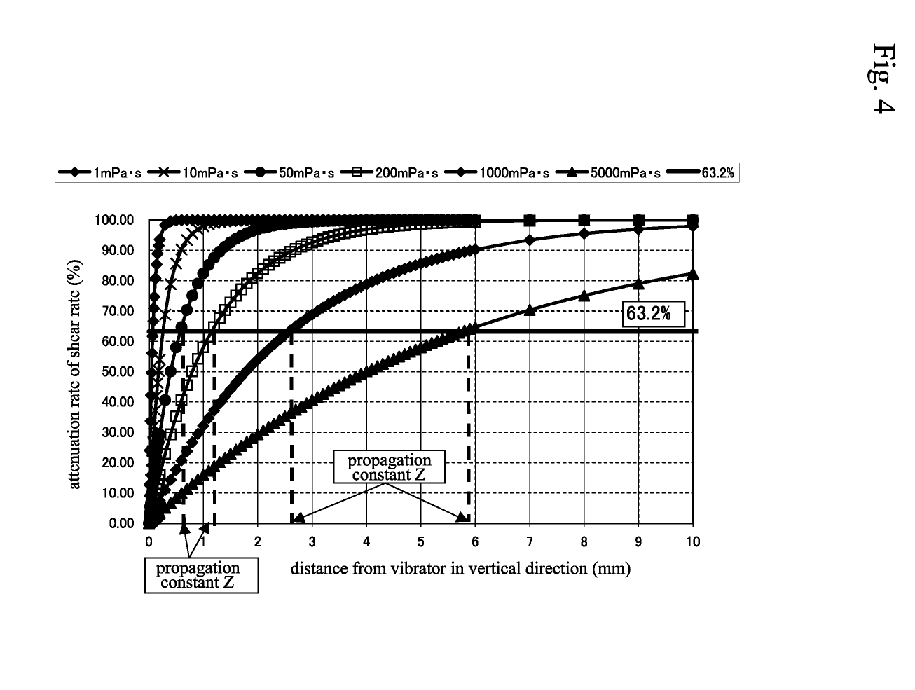

The graph of FIG. 4 is depicted while the viscosities (η) in Equation (5) were adjusted to be 1 mPa*s, 10 mPa*s, 50 mPa*s, 200 mPa*s, 1000 mPa*s and 5000 mPa*s, and the angular rate (ω) was 118.4 (rad/sec) (vibration frequency: 30 Hz) for the respective viscosities, and the density was a variable for the respective viscosities.

FIG. 4 is the graph explaining the propagation constants of the shear rates in which the ordinate axis indicates the attenuation rate [%] of the shear rate, and the abscissa axis indicates the distance [mm] from the vibrators in the vertical direction (y-direction).

When the intersections between the asymptotic curve of the attenuation rate (δ) and the linear line (y=0.632) are read out, the propagation constants Z are 0.07 mm, 0.26 mm, 0.57 mm, 1.15 mm, 2.58 mm and 5.76 in case of the viscosities of 1 mPa*s, 10 mPa*s, 50 mPa*s, 200 mPa*s, 1000 mPa*s and 5000 mPa*s, respectively. These are the reachable ranges. The higher viscosity increases the propagation constant Z, the viscosity is hardly attenuated, and the constant Z extends to a longer distance. This means that the influence is likely produced in the higher viscosity with the approach of the vibrators 1.1 to the wall of the vessel 7, and that the reasonableness of the dimension of the measurement vessel and the adequacy of the dimension of the stirring apparatus for the liquid for both of the Newtonian fluid and the non-Newtonian fluid can be examined.

The above propagation constant Z can be mathematically obtained by using Equation (5).

In the asymptotic equation “1−exp^{-x}” (“x” is a variable), the final value of 63.2% is obtained when “x=1” is satisfied (“1−exp^{-x}”=0.632). Accordingly, the condition when the attenuation rate (δ) is equal to 63.2% is specified by Equation (6).

$$\begin{matrix}[ Equation 6 ] & \\ \sqrt{\frac{ω ρ}{η}} y = 1 & ( 6 )\end{matrix}$$

Accordingly, in Equation (6), when the propagation constant Z is assumed to be the distance “y” in which the attenuation rate (δ) is equal to 63.2%, the constant Z is obtained by using Equation (1).

$$\begin{matrix}[ Equation 1 ] & \\ Z = \frac{1}{\sqrt{\frac{ω ρ}{η}}} & ( 1 )\end{matrix}$$

That is, the shear rate propagation constant Z can be obtained by using the angular frequency (ω), the density of the fluid (ρ), and the viscosity of the fluid (η).

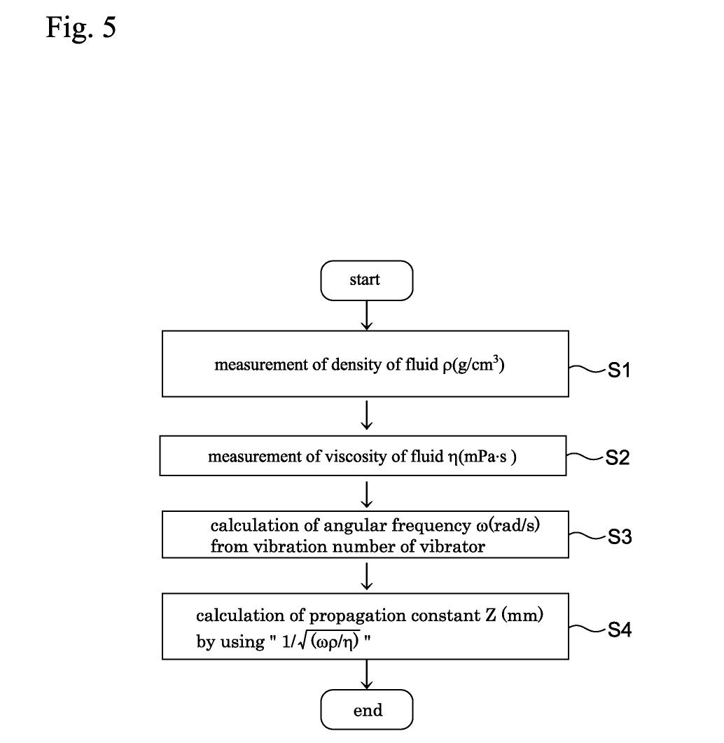

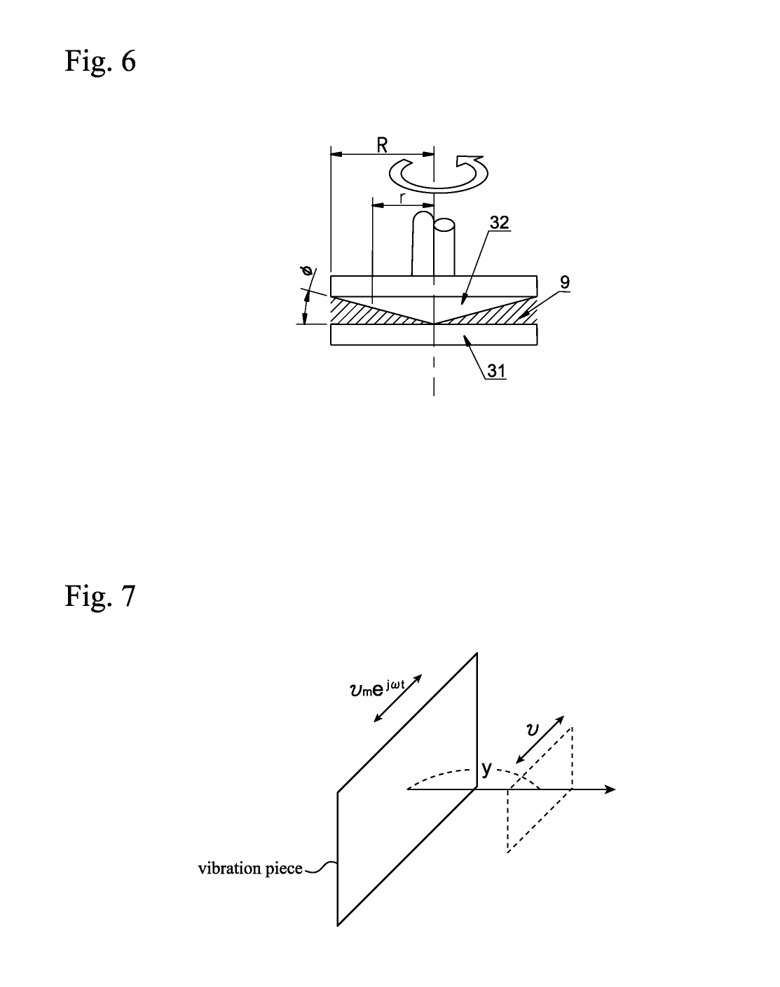

FIG. 5 is a flowchart for calculating the shear rate propagation constant.

After the start of the measurement, the process proceeds to a step S1 in which the density (ρ) value of the sample liquid 9 is measured (density measuring step). This density is measured by using a known density measuring apparatus. When a standard solution having a known density exists, this density can be directly inputted through the key switch section 23 or can be read out from the memory 21 after it is stored in a table in advance.

Then, the process proceeds to a step S2 in which the viscosity (η) value of the sample liquid 9 is measured (viscosity measuring step). In the measurement, the viscosity (η) is preferably obtained when the measured value is stabilized after the start of the measurement. When a standard solution having a known viscosity exists without the measurement, it can be directly inputted through the key switch section 23 or can be read out from the memory 21 after it is stored in a table in advance.

Then, the process proceeds to a step S3 in which the angular frequency (ω) [rad/s] is calculated from the frequency “f” of the vibrators 1,1 (angular frequency calculating step).

Then, the process proceeds to a step S4 in which the shear rate propagation constant Z is calculated by using Equation (1) in the operation processing part 18 (propagation constant calculating step), and the measurement is terminated. These processings are conducted at the operation processing part 18 (propagation constant calculating means).

The shear rate propagation constant Z obtained in the step S4 is shown on the display 22 upon request of a user. The respective values can be stored in the memory 21 and be compared with the measurement results of other sample liquids on a display. If necessary, the shear rate propagation constants Z of a plurality of sample liquids can be shown in a format of FIG. 4. The steps S1 to S3 may be performed in no particular order.

### Example 1

ω: angular frequency of vibration piece. When the vibrator 1 vibrates at 30 Hz, ω=2Πf is satisfied so that ω=2×3.14×30=188.4 [rad/s].

ρ: density of fluid, ρ=0.8 [g/cm³] in accordance with the measurement.

η: viscosity of fluid, η=100 [mPa·s] in accordance with the measurement.

The shear rate propagation constant Z calculated by using these values is specified below.

$$\begin{matrix}[ Equation 7 ] & \\ Z = \frac{1}{\sqrt{\frac{188.4 \times 0.8}{1000}}} = 2.58 [ mm ] & \end{matrix}$$

### Example 2

ω: angular frequency of vibration piece. When the vibrator 1 vibrates at 30 Hz, ω=2Πf is satisfied so that ω=2×3.14×30=188.4 [rad/s].

ρ: density of fluid, ρ=1.2 [g/cm³] in accordance with the measurement.

η: viscosity of fluid, η=10 [mPa·s] in accordance with the measurement.

The shear rate propagation constant Z calculated by using these values is specified below.

$$\begin{matrix}[ Equation 8 ] \\ Z = \frac{1}{\sqrt{\frac{188.4 \times 1.2}{10}}} = 0.21 [ mm ]\end{matrix}$$

In the method of calculating the reachable range of the shear rate in accordance with the present invention, the reachable range of the shear rate exerted on the fluid (sample liquid 9) from the vibrators 1,1 can be quantified and evaluated by utilizing the new concept of the propagation constant Z calculated from the density (ρ) of the fluid (sample liquid 9), the viscosity (η) of the fluid (sample liquid 9) and the angular frequency (ω) of the vibrators 1,1.

### DESCRIPTION OF SYMBOLS

1 vibrator

1a vibration surface

2 electromagnetic drive

2a neodymium magnet

2b electromagnetic coil

7 vessel

8 fluid (sample liquid)

10 drive mechanism part

18 operation processing part

100 viscometer body

1. A method of evaluating a property of a fluid in an apparatus for measuring a viscosity in which a vibrator dunked in the fluid and to be measured is vibrated for measuring the viscosity by means of an amplitude change which is influenced by a viscosity resistance of the fluid, the method comprising:
a step of measuring a density “ρ” of the fluid;
a step of measuring the viscosity “η” of the fluid;
a step of calculating an angular frequency “ω” of the vibrator; and
a step of calculating a shear rate propagation constant “Z” in accordance with an Equation (1) below,
wherein an increase of the shear rate propagation constant “Z” is evaluated as an increase of a reachable range of the shear rate applied to the fluid from the vibrator.
$$\begin{matrix}[ Equation 1 ] & \\ Z = \frac{1}{\sqrt{\frac{ω ρ}{η}}} & ( 1 )\end{matrix}$$

2. A method of evaluating a property of a fluid in an apparatus for measuring a viscosity in which a vibrator dunked in the fluid and to be measured is vibrated for measuring the viscosity by means of an amplitude change which is influenced by a viscosity resistance of the fluid, the method comprising:
a step of measuring a density “ρ” of the fluid;
a step of measuring the viscosity “η” of the fluid;
a step of calculating an angular frequency “ω” of the vibrator; and
a step of calculating a shear rate propagation constant “Z” in accordance with an Equation (1) below,
wherein a reachable range of the shear rate is quantified by using the shear rate propagation constant “Z”.
$$\begin{matrix}[ Equation 1 ] & \\ Z = \frac{1}{\sqrt{\frac{ω ρ}{η}}} & ( 1 )\end{matrix}$$

3. A tuning-fork vibration type viscometer comprising:
a pair of vibrators dunked in a fluid to be measured; and
an electromagnetic drive provided with a coil for driving the vibrators,
wherein a driving current is applied to the coil such that an amplitude of the vibrators which is changed by a viscosity resistance of the fluid reaches a predetermined value, and a viscosity “η” of the fluid is obtained by measuring the driving current,
an angular frequency “ω” of the vibrators is calculated, and
a means of calculating a shear rate propagation constant “Z” is provided in an operation processing part in accordance with an Equation (1) below and by using the angular frequency “ω”, the viscosity “η” and a density “ρ” of the fluid.
$$\begin{matrix}[ Equation 1 ] & \\ Z = \frac{1}{\sqrt{\frac{ω ρ}{η}}} & ( 1 )\end{matrix}$$

4. A program of calculating the shear rate propagation constant which is written in accordance with the method of evaluating the property of the fluid in the apparatus claimed in claim 1, and is executable.

5. A program of calculating the shear rate propagation constant which is written in accordance with the method of evaluating the property of the fluid in the apparatus claimed in claim 2, and is executable.
